(19) United States
(12) Patent Application Publication
(10) Pub. No.: US 2016/0204623 A1
(43) Pub. Date: Jul. 14, 2016

(54) CHARGE LIMIT SELECTION FOR VARIABLE POWER SUPPLY CONFIGURATION

(71) Applicant: Hand Held Products, Inc., Fort Mill, SC (US)

(72) Inventors: Thomas Haggerty, Collingswood, NJ (US); Christopher Allen, East Windsor, NJ (US); Stephen J. Colavito, Garnet Valley, PA (US)

(21) Appl. No.: 14/972,460

(22) Filed: Dec. 17, 2015

Related U.S. Application Data
(60) Provisional application No. 62/101,235, filed on Jan. 8, 2015.

(51) Int. Cl. H02J 7/00

(52) U.S. Cl. CPC H02J 7/007; H02J 7/0042; H02J 7/0052; H02J 2007/0062

(57) ABSTRACT

A method includes charging a device coupled to a charger, detecting a charger attached power supply configuration, and limiting a charge current of the charger based on the detected power supplies.

### CROSS-REFERENCE TO RELATED APPLICATION

The present application claims the benefit of U.S. Patent Application No. 62/101,235 for Charge Limit Selection for Variable Power Supply Configuration filed Jan. 8, 2015. The foregoing patent application is hereby incorporated by reference in its entirety.

### FIELD OF THE INVENTION

The invention is generally related to a variable power supply configuration, and, more specifically, to a variable power supply configuration having multiple power supplies.

### BACKGROUND

Some devices with charge storage capabilities, such as batteries, capacitors, or supercapacitors, can be connected to multiple power supplies for charging or powering the device directly—either at different times or simultaneously. Commonly, each of these power supplies is capable of sourcing a different amount of power to the device.

If the charge circuitry that limits the charging rate is built into the device itself, and not into the supplies, the charging rate is typically limited to that of the weakest supply. For example, if the device is a hard drive having a USB connector and a separate barrel connector for plugging in an AC adaptor, the USB connector may be able to supply 500 mA of current, while the barrel adapter may be able to supply 1 A. Typically, the device will have a built-in charging rate that is limited to the lowest charging rate, which would be 500 mA in this example. Thus, the device protects overcurrent to the USB host when the barrel connector is attached. This is conventional approach, while protecting the weakest supply, is suboptimal, since the device is unable to utilize the available higher charging rate. Thus, the device has a charging time that is longer than necessary. Additionally, for devices without a battery, being limited to the lowest charging rate can limit the device's functionality, when such functionality could be enhanced by the available higher charging rate.

### SUMMARY

In an aspect of the invention, a method comprises the steps of charging a device coupled to a charger; detecting a charger attached power supply configuration; and limiting a charge current of the charger based on the detected power supplies.

In an embodiment, detecting an attached power supply configuration includes detecting changes to the power supply configuration.

In another embodiment, detecting changes includes detecting insertion and removal of power supply connectors to the charger while charging the device.

In an embodiment, the charger supply configuration comprises at least one of a USB power supply coupled to the charger via a USB connector and an AC adapter power supply coupled to the charger via a barrel connector.

In an embodiment, a USB power supply is coupled to the charger and wherein upon detection of an AC adapter power supply being connected, the method further comprises disabling a USB charge path.

In an embodiment, upon detection of only a USB power supply being coupled to the charger, the charge current is limited to approximately 500 mA.

In an embodiment, limiting a charge current comprises limiting charge current in a USB charge path independently of limiting charge current in a separate AC adapter charge path.

In another embodiment, the current in the USB charge path is limited to approximately 500 mA and the current in the AC adapter charge path is limited to approximately 1 A.

In an embodiment, detecting a charger attached power supply configuration comprises detecting the presence of a supply voltage on a given input pin.

In an embodiment, detecting a charger attached power supply configuration comprises receiving an identification signal from an attached power supply.

In another aspect of the invention, a device comprises a charger connector; a power supply configuration detector coupled to the charger connector to detect a power supply configuration; and a current limiter coupled to the power supply configuration detector to limit charge current based on the detected power supply configuration.

In an embodiment, the charger connector comprises a cradle having multiple pins to couple to a charge storage element.

In another embodiment, the power supply configuration detector detects changes to the power supply configuration.

In yet another embodiment, the power supply configuration detector detects insertion and removal of power supply connectors to the charger while charging the device.

In an embodiment, the charger supply configuration comprises at least one of a USB power supply to couple to the charger via a USB connector and an AC adapter power supply to couple to the charger via a barrel connector.

In yet another embodiment, the device further includes separate charge paths for each different power supply in the power supply configuration.

In yet another embodiment, the current limiter is configured to disable a USB charge path upon detection of an AC adapter power supply being connected.

In an embodiment, the current limiter is configured to limit charge current to approximately 500 mA when a USB power supply is connected to the charge connector.

In another embodiment, the current limiter limits a charge current in a USB charge path independently of limiting charge current in a separate AC adapter charge path.

In an embodiment, the current in the USB charge path is limited to approximately 500 mA and the current in the AC adapter charge path is limited to approximately 1 A.

In an embodiment, the power supply configuration detector detects the presence of a supply voltage on a given input pin.

In an embodiment, the power supply configuration detector receives an identification signal from an attached power supply.

### BRIEF DESCRIPTION OF THE DRAWINGS

The invention will now be described by way of example, with reference to the accompanying Figures, of which:

FIG. 1 is a schematic diagram of a variable power supply assembly connected to a charge storage element;

FIG. 2 is a schematic diagram of the variable power supply assembly connected to a device;

FIG. 3 is a schematic diagram of a variable power supply assembly connected to device components and a charge storage element;

FIG. 4 is a schematic of a computing device;

FIG. 5 is a schematic diagram of a variable power supply assembly having a two power supply sources independently limited by one or more current limiters; and

FIG. 6 is a block diagram of a method of charge limit selection for the variable power supply assembly.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and those skilled in the art would understood that other embodiments may be utilized and that structural, logical, and electrical changes may be made without departing from the scope of the invention. The following description of exemplary embodiments is, therefore, not to be taken in a limited sense, and the scope of the invention is defined by the appended claims.

The functions or algorithms described herein may be implemented in software or a combination of software and human implemented procedures in one embodiment. The software may consist of computer executable instructions stored on computer readable media or computer readable storage device such as one or more memory or other type of hardware based storage devices, either local or networked. Further, such functions correspond to modules, which are software, hardware, firmware, or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

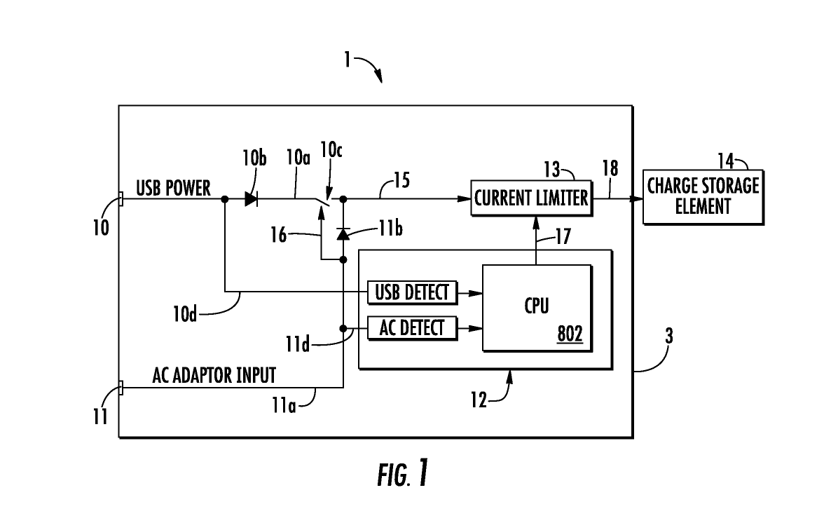

In an embodiment shown in FIG. 1, a variable power supply assembly 1 includes a first charger connector 10, a second charger connector 11, a power supply configuration detector 12, a current limiter 13, and a charge storage element 14. In an embodiment, the variable power supply assembly 1 is housed in a recharging cradle 3.

In an embodiment, the first charger connector 10 is a universal serial bus (“USB”) connector 10. The USB connector 10 includes one or more first power supply pins, and has a maximum current of approximately 500 mA.

In an embodiment, the second charger connector 11 is an AC connector 11. The AC connector 11 can be a barrel connector, or any other type of common AC connector. The AC connector 11 includes one or more second power supply pins, and has a maximum current greater than 500 mA. In an embodiment, the AC connector 11 has a maximum current of 1-5 A. In another embodiment, the AC connector 11 has a maximum current of 1-3 A. In yet another embodiment, the AC connector 11 has a maximum current of 1 A.

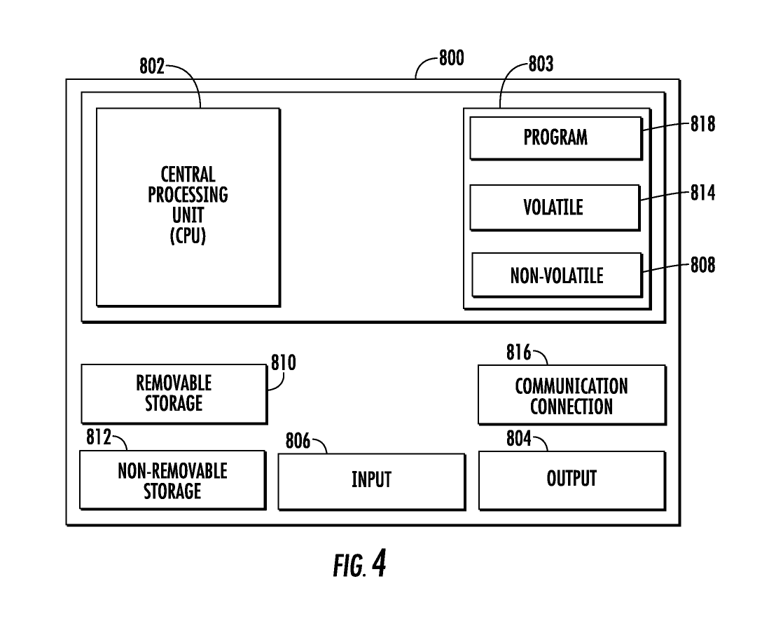

As shown in an embodiment of FIGS. 1 and 4, the power supply configuration detector 12 includes a computer system or device 800. The computing device 800 includes one or more of a central processing unit 802 (“CPU”), memory 803, removable storage 810, and non-removable storage 812. Although various data storage elements are shown as part of the computing device 800, the storage may also or alternatively include cloud-based storage accessible via a network, such as the Internet.

Memory 803 may include volatile memory 814 and non-volatile memory 808. Computing device 800 may include—or have access to a computing environment that includes—a variety of computer-readable media, such as volatile memory 814 and non-volatile memory 808, removable storage 810 and non-removable storage 812. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computing device 800 can include or have access to a computing environment that includes input 806, output 804, and a communication connection 816. Output 804 may include a display device, such as a touchscreen, that also may serve as an input device. The input 806 may include one or more of a touchscreen, touchpad, mouse, keyboard, camera, one or more device-specific buttons, one or more sensors integrated within or coupled via wired or wireless data connections to the computing device 800, and other input devices. The computing device 800 may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), cellular, WiFi, Bluetooth, or other networks.

Computer-readable instructions stored on a computer-readable medium are executable by the central processing unit 802 of the computing device 800. A hard drive, CD-ROM, and RAM are some examples of articles including a non-transitory computer-readable medium such as a storage device. The terms computer-readable medium and storage device do not include carrier waves. For example, a computer program 818 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 800 to provide generic access controls in a COM based computer network system having multiple users and servers.

In an embodiment, the current limiter 13 is a feedback loop with a setpoint controlled by the CPU 802. For example, the feedback loop can include a series resistance connected to an amplifier, which is used to measure an input current; an error amplifier, which provides negative feedback using a measured current and a setpoint; and a transistor, which is modulated by the error amplifier to produce a regulated output current.

In an embodiment, the charge storage element 14 is a battery. The battery 14 can include nickel cadmium, lithium, or any other rechargeable battery type known to those of ordinary skill in the art. In another embodiment, the charge storage element 14 is capacitor, a supercapacitor, or an ultracapacitor. The super- or ultracapacitor is known to those of ordinary skill in the art as capacitors that have a very high capacitance compared to traditional capacitors. Generally, traditional capacitors have two plates separated by a relatively thick dielectric composed of mica (ceramic), a thin plastic film, or even air. The super- or ultracapacitor also uses two plates, but these plates have a much higher surface area and are separated by a very thin insulator, generally composed of carbon, paper, or plastic.

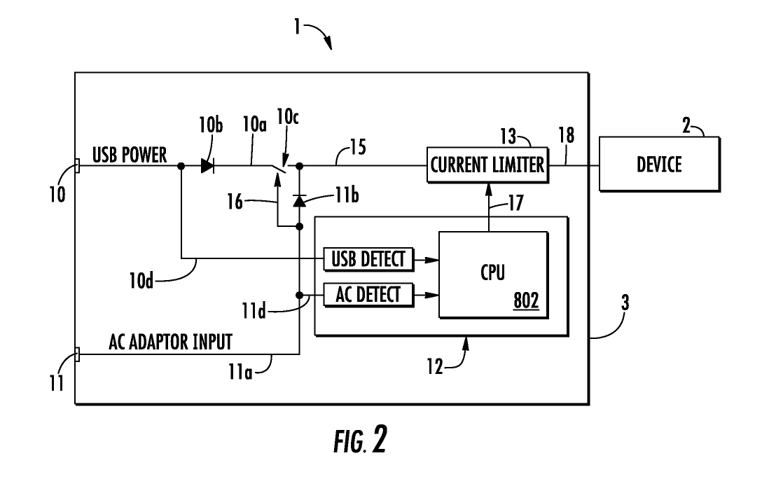

In an embodiment shown in FIG. 2, the variable power supply assembly 1 operates in the absence of the charge storage element 14. Instead, a device 2 is powered directly from power output from the current limiter 13 rather than power stored by the charge storage element 14.

In the embodiments shown in FIGS. 1 and 2, the first charger connector 10 has a first current path 10a that connects to a primary current path 15. The primary current path 15 is connected to the current limiter 13. The first current path 10a includes a first diode 10b, where the first diode 10b prevents back-feeding from the second charger connector 11 into the first charger connector 10.

In an embodiment, the first current path 10a includes a disabling switch 10c. The disabling switch 10c is positioned between the first diode 10b and the primary current path 15.

A first connector detection path 10d connects the first current path 10a to the CPU 802 of the power supply configuration detector 12.

In the embodiments shown in FIGS. 1 and 2, the second charger connector 11 has a second current path 11a that connects to the primary current path 15. The second current path 11a includes a second diode 11b, where the second diode 11b prevents back-feeding from the first charger connector 10 into the second charger connector 11.

A second connector detection path 11d connects the second current path 11a to the CPU 802 of the power supply configuration detector 12.

In an embodiment shown in FIG. 1, a switch activating path 16 is connected to the second current path 11a and the disabling switch 10c. The switch activating path 16 is connected to the second current path 11a between the second charge connector 11 and the second diode 11b. When current is applied along the second current path 11a, the current is also applied along the switch activating path 16, which opens the disabling switch 10c. Thusly, the disabling switch 10c disables the first current path 10a nearly instantaneously when current flows along the second current path 11a. This disabling action prevents overcurrent along the first current path 10a. Conversely, when current along the second current path 11b is removed, the disabling switch 10c switches to a closed position, allowing current from the first charger connector 10 to flow to the primary current path 15.

The CPU 802 of the power supply configuration detector 12 is connected to the current limiter 13 through a control path 17, and the current limiter 13 is connected to the charge storage element 14 or other components of the device through a charging path 18.

The CPU 802 is communicatively coupled to the current limiter 13 through the control path 17, and controls a level of charge current output along the charging path 18, based on the detected power supply configuration of the first and second connector detection paths 10d, 11d. In the exemplary embodiments shown in FIGS. 1 and 4, CPU 802 accesses current controlling software stored in memory 803, and calculates and sets a current level output by the current limiter 13 to the charging path 18. Specifically, the CPU 802 detects the presence of, and changes to, a supply current from the first or second charger connector 10,11 along the first and second current paths 10d,11d, respectively. In an embodiment, the CPU 802 receives an identification signal from an attached power supply to the first or second charger connector 10,11 using a known, simple communication protocol when the supply is connected, and the CPU 802 adjusts the current level output by the current limiter 13 to the charging path 18 accordingly. An advantage to using the identification signal is it allows for different types of power supplies of the same voltage, but different maximum currents, to be connected to the same physical input port. In another embodiment, the CPU 802 detects insertion and removal of power supply connectors to the first and second charger connectors 10,11 while charging the charge storage element.

In an embodiment, the current limiter 13 is configured to limit charge current output to approximately 500 mA when a USB power supply is connected to the first charger connector 10. In another embodiment, the current limiter 13 is configured to limit charge current output to approximately 1 mA when an AC power supply is connected to the second charger connector 11.

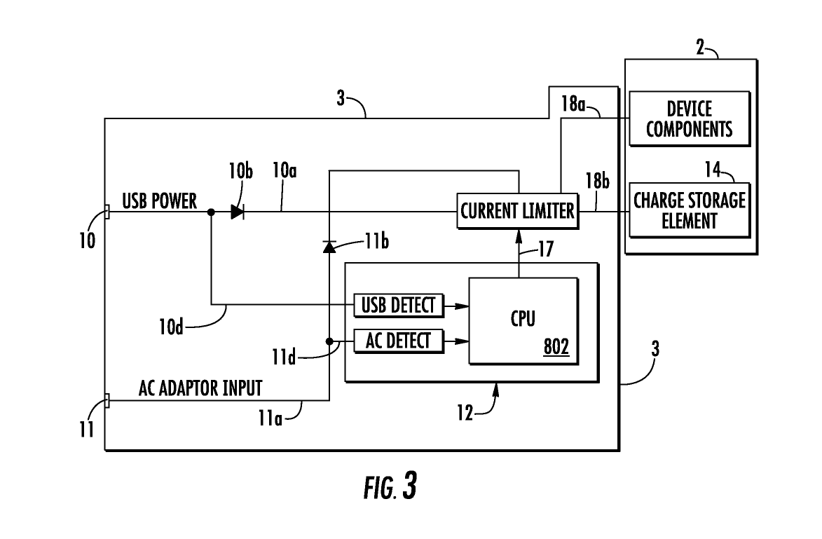

In an embodiment shown in FIG. 3, the current limiter 13 limits a charge current in the first current path 10a independently of limiting charge current in the separate second current path 11a. The first charger connector 10 is directly connected to a first input of the current limiter 13 through the first current path 10a, and the second charger connector 11 is directly connected to a second input of the current limiter 13 through the second current path 11a. In an embodiment, the first current path 10a optionally includes the first diode 10b. In another embodiment, the first current path 10a optionally includes the disabling switch 10c connected to the switch activating path 16.

As shown in the embodiment of FIG. 3, the current limiter 13 includes a first output charging path 18a and a second output charging path 18b. A current output level from the current limiter 13 to either the first output charging path 18a or second output charging path 18b can correspond to either of the current input levels from the first charger connector 10 and second charger connector 11 to the current limiter 13. For example, the current input from the first charger connector 10 can be output along the first output charging path 18a, and the current input from the second charger connector 11 can be output along the second output charging path 18b, or vice versa.

Thusly, in the embodiment of FIG. 3, the variable power supply assembly 1 permits an output of a summation of currents from multiple supplies. In an exemplary embodiment (not shown), the output of the summation of currents is used to charge the device 2 simultaneously for improved charging times. For example, the charging base 3 (cradle) could draw power through the first charger connector 10, and simultaneously draw power from the second charger connector 11 to power wireless charging circuitry. When the device 2 is cradled, as described in FIG. 3, the device 2 could simultaneously receive current charge, independent limited, from both charger connectors 10,11.

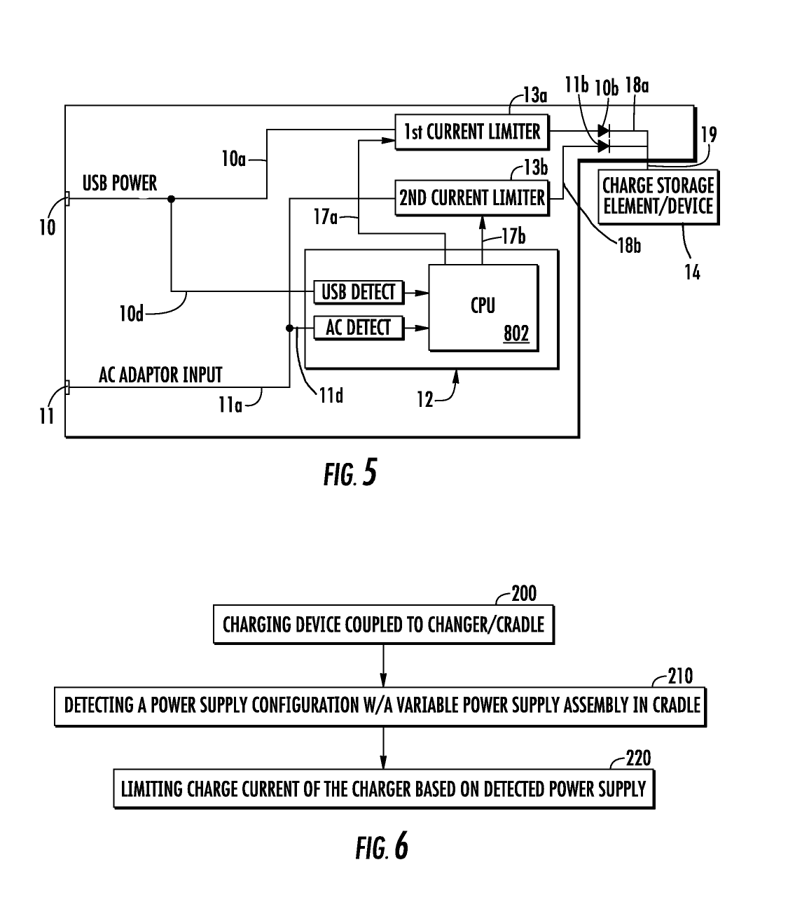

In an embodiment shown in FIG. 5, the variable power supply assembly 1 includes a first current limiter 13a and a second current limiter 13b. The first current limiter 13a has an input connected to the first charger connector 10 by the first current path 10a, and the second current limiter 13b has an input connected to the second charger connector 10 by the second current path 11a. In an embodiment, the first and second current paths 10a,11a optionally include the first and second diodes 10b,11b, respectively. In another embodiment, the first current path 10a optionally includes the disabling switch 10c connected to the switch activating path 16 shown in FIG. 1. A first output charging path 18a is connected to an output of the first current limiter 13a, and a second output charging path 18b is connected to an output of the second current limiter 13b. The first output charging path 18a and the second output charging path 18b are connected to form an OR function, specifically, an OR gate. The first output charging path 18a includes the first diode 10b, and the second output charging path 18b includes the second diode 11b. The first output charging path 18a and the second output charging path 18b connect to a combined charging path 19 that in turn, connects with the charge storage element 14 and/or device 2.

In an embodiment not shown, but readily understood by those of ordinary skill in the art, the single current limiter 13 shown in FIG. 3 is replaced with the first and second current limiters 13a,13b shown in FIG. 5. Thus, in an embodiment, the first output charging path 18a, rather than connecting with the second output charging path 18b, would instead connect independently to either device components or the charge storage element 14, as shown for example in the embodiment of FIG. 3. Similarly, the second output charging path 18b, rather than connecting with the first output charging path 18a, would instead connect independently to the other of either the device components or the charge storage element 14, as shown for example in the embodiment of FIG. 4.

In the embodiment shown in FIG. 5, the CPU 802 of the power supply configuration detector 12 is connected to the first current limiter 13a through a first control path 17a, and is connected to the second current limiter 13b through a second control path 17b. As described in the above embodiments, CPU 802 controls a level of charge current output from the first and second current limiters 13a,13b along the first and second output charging paths 18a,18b, respectively, based on the detected power supply configuration of the first and second connector detection paths 10d, 11d.

In an embodiment shown in FIG. 6, a method includes the step of charging a device 2 coupled to a cradle 3 having first and/or second charger connectors 10,11 at block 200.

A variable power supply assembly 1 in the cradle 3 detects a power supply configuration, such as a USB charger connection or an AC charger connection at block 210. In an embodiment, when detecting an attached power supply configuration, changes to the power supply configuration are detected. In another embodiment, detecting changes to the power supply configuration includes detecting insertion and removal of power supply of the first and second charger connectors 10,11 to the cradle 3 while charging the device 2. In an embodiment, detecting a charger attached power supply configuration includes detecting the presence of a supply voltage on a given input pin in the first or second charger connectors 10,11. In another embodiment, detecting a charger attached power supply configuration includes receiving an identification signal from an attached power supply from the first or second charger connectors 10,11.

An output charge current limit based on the detected power supplies of the first or second charger connectors 10,11 is set at block 220. In an embodiment, when a USB power supply is coupled to the charger 3 via the first charger connector 10, upon detection of an AC adapter power supply being connected to the charger 3 via the second charger connector 11, the method further includes disabling a USB charge path. In an embodiment, limiting a charge current includes limiting charge current in a USB charge path 10a independently of limiting charge current in a separate AC adapter charge path 11a.

In an embodiment, upon detection of only a USB power supply being coupled via the first charger connector 10 to the charger 3, the charge current is limited to approximately 500 mA. In an embodiment, the current in the USB charge path is limited to approximately 500 mA and the current in the AC adapter charge path is limited to approximately 1 A.

As described above, in one aspect of the invention, a device utilizes a maximum available supply power by rapidly detecting changes to an attached power supply configuration and limiting charge current based on the available power supplies. The device can detect the insertion and removal of power supplies at runtime and adjust the charge current limit based on the updated supply configuration. If, at a certain time, a USB connector alone is attached, the device detects the absence of the AC adapter connector and limits the charging current to a maximum of 500 mA. If an AC adapter is later connected, the device detects the insertion event, disables the USB supply path, and increases the maximum charge current to 1 A.

In another exemplary embodiment, the USB and adapter power paths are independently limited by one or more current limiters, and may be combined to use a total available power. Thus, upon detection of both a USB and AC adapter power supply, the device may raise the charge current limit to 1.5 A on detection of the adapter, and thus use the total available power.

To supplement the present disclosure, this application incorporates entirely by reference the following commonly assigned patents, patent application publications, and patent applications:

U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Patent No. D716,285;
U.S. Design Patent No. D723,560;
U.S. Design Patent No. D730,357;
U.S. Design Patent No. D730,901;
U.S. Design Patent No. D730,902;
U.S. Design Patent No. D733,112;
U.S. Design Patent No. D734,339;

### International Publication No. 2013/163789;

### International Publication No. 2013/173985;

### International Publication No. 2014/019130;

### International Publication No. 2014/110495;

### U.S. Patent Application Publication No. 2008/0185432;

### U.S. Patent Application Publication No. 2009/0134221;

### U.S. Patent Application Publication No. 2010/0177080;

### U.S. Patent Application Publication No. 2010/0177076;

### U.S. Patent Application Publication No. 2010/0177707;

### U.S. Patent Application Publication No. 2010/0177749;

### U.S. Patent Application Publication No. 2010/0265880;

### U.S. Patent Application Publication No. 2011/0202554;

### U.S. Patent Application Publication No. 2012/0111946;

### U.S. Patent Application Publication No. 2012/0168511;

### U.S. Patent Application Publication No. 2012/0168512;

### U.S. Patent Application Publication No. 2012/0193423;

### U.S. Patent Application Publication No. 2012/0203647;

### U.S. Patent Application Publication No. 2012/0223141;

### U.S. Patent Application Publication No. 2012/0228382;

### U.S. Patent Application Publication No. 2012/0248188;

### U.S. Patent Application Publication No. 2013/0043312;

### U.S. Patent Application Publication No. 2013/0082104;

### U.S. Patent Application Publication No. 2013/0175341;

### U.S. Patent Application Publication No. 2013/0175343;

### U.S. Patent Application Publication No. 2013/0257744;

### U.S. Patent Application Publication No. 2013/0257759;

### U.S. Patent Application Publication No. 2013/0270346;

### U.S. Patent Application Publication No. 2013/0287258;

### U.S. Patent Application Publication No. 2013/0292475;

### U.S. Patent Application Publication No. 2013/0292477;

### U.S. Patent Application Publication No. 2013/0293539;

### U.S. Patent Application Publication No. 2013/0293540;

### U.S. Patent Application Publication No. 2013/0306728;

### U.S. Patent Application Publication No. 2013/0306731;

### U.S. Patent Application Publication No. 2013/0307964;

### U.S. Patent Application Publication No. 2013/0308625;

### U.S. Patent Application Publication No. 2013/0313324;

### U.S. Patent Application Publication No. 2013/0313325;

### U.S. Patent Application Publication No. 2013/0342717;

### U.S. Patent Application Publication No. 2014/0001267;

### U.S. Patent Application Publication No. 2014/0008439;

### U.S. Patent Application Publication No. 2014/0025584;

### U.S. Patent Application Publication No. 2014/0034734;

### U.S. Patent Application Publication No. 2014/0036848;

### U.S. Patent Application Publication No. 2014/0039693;

### U.S. Patent Application Publication No. 2014/0042814;

### U.S. Patent Application Publication No. 2014/0049120;

### U.S. Patent Application Publication No. 2014/0049635;

### U.S. Patent Application Publication No. 2014/0061306;

### U.S. Patent Application Publication No. 2014/0063289;

### U.S. Patent Application Publication No. 2014/0066136;

### U.S. Patent Application Publication No. 2014/0067692;

### U.S. Patent Application Publication No. 2014/0070005;

### U.S. Patent Application Publication No. 2014/0071840;

### U.S. Patent Application Publication No. 2014/0074746;

### U.S. Patent Application Publication No. 2014/0076974;

### U.S. Patent Application Publication No. 2014/0078341;

### U.S. Patent Application Publication No. 2014/0078345;

### U.S. Patent Application Publication No. 2014/0097249;

### U.S. Patent Application Publication No. 2014/0098792;

### U.S. Patent Application Publication No. 2014/0100813;

### U.S. Patent Application Publication No. 2014/0103115;

### U.S. Patent Application Publication No. 2014/0104413;

### U.S. Patent Application Publication No. 2014/0104414;

### U.S. Patent Application Publication No. 2014/0104416;

### U.S. Patent Application Publication No. 2014/0104451;

### U.S. Patent Application Publication No. 2014/0106594;

### U.S. Patent Application Publication No. 2014/0106725;

### U.S. Patent Application Publication No. 2014/0108010;

### U.S. Patent Application Publication No. 2014/0108402;

### U.S. Patent Application Publication No. 2014/0110485;

### U.S. Patent Application Publication No. 2014/0114530;

### U.S. Patent Application Publication No. 2014/0124577;

### U.S. Patent Application Publication No. 2014/0124579;

### U.S. Patent Application Publication No. 2014/0125842;

### U.S. Patent Application Publication No. 2014/0125853;

### U.S. Patent Application Publication No. 2014/0125999;

### U.S. Patent Application Publication No. 2014/0129378;

### U.S. Patent Application Publication No. 2014/0131438;

### U.S. Patent Application Publication No. 2014/0131441;

### U.S. Patent Application Publication No. 2014/0131443;

### U.S. Patent Application Publication No. 2014/0131444;

### U.S. Patent Application Publication No. 2014/0131445;

### U.S. Patent Application Publication No. 2014/0131448;

### U.S. Patent Application Publication No. 2014/0133379;

### U.S. Patent Application Publication No. 2014/0136208;

### U.S. Patent Application Publication No. 2014/0140585;

### U.S. Patent Application Publication No. 2014/0151453;

### U.S. Patent Application Publication No. 2014/0152882;

### U.S. Patent Application Publication No. 2014/0158770;

### U.S. Patent Application Publication No. 2014/0159869;

### U.S. Patent Application Publication No. 2014/0166755;

### U.S. Patent Application Publication No. 2014/0166759;

### U.S. Patent Application Publication No. 2014/0168787;

### U.S. Patent Application Publication No. 2014/0175165;

### U.S. Patent Application Publication No. 2014/0175172;

### U.S. Patent Application Publication No. 2014/0191644;

### U.S. Patent Application Publication No. 2014/0191913;

### U.S. Patent Application Publication No. 2014/0197238;

### U.S. Patent Application Publication No. 2014/0197239;

### U.S. Patent Application Publication No. 2014/0197304;

### U.S. Patent Application Publication No. 2014/0214631;

### U.S. Patent Application Publication No. 2014/0217166;

### U.S. Patent Application Publication No. 2014/0217180;

### U.S. Patent Application Publication No. 2014/0231500;

### U.S. Patent Application Publication No. 2014/0232930;

### U.S. Patent Application Publication No. 2014/0247315;

### U.S. Patent Application Publication No. 2014/0263493;

### U.S. Patent Application Publication No. 2014/0263645;

### U.S. Patent Application Publication No. 2014/0267609;

### U.S. Patent Application Publication No. 2014/0270196;

### U.S. Patent Application Publication No. 2014/0270229;

### U.S. Patent Application Publication No. 2014/0278387;

### U.S. Patent Application Publication No. 2014/0278391;

### U.S. Patent Application Publication No. 2014/0282210;

### U.S. Patent Application Publication No. 2014/0284384;

### U.S. Patent Application Publication No. 2014/0288933;

### U.S. Patent Application Publication No. 2014/0297058;

### U.S. Patent Application Publication No. 2014/0299665;

### U.S. Patent Application Publication No. 2014/0312121;

### U.S. Patent Application Publication No. 2014/0319220;

### U.S. Patent Application Publication No. 2014/0319221;

### U.S. Patent Application Publication No. 2014/0326787;

### U.S. Patent Application Publication No. 2014/0332590;

### U.S. Patent Application Publication No. 2014/0344943;

### U.S. Patent Application Publication No. 2014/0346233;

### U.S. Patent Application Publication No. 2014/0351317;

### U.S. Patent Application Publication No. 2014/0353373;

### U.S. Patent Application Publication No. 2014/0361073;

### U.S. Patent Application Publication No. 2014/0361082;

### U.S. Patent Application Publication No. 2014/0362184;

### U.S. Patent Application Publication No. 2014/0363015;

### U.S. Patent Application Publication No. 2014/0369511;

### U.S. Patent Application Publication No. 2014/0374483;

### U.S. Patent Application Publication No. 2014/0374485;

### U.S. Patent Application Publication No. 2015/0001301;

### U.S. Patent Application Publication No. 2015/0001304;

### U.S. Patent Application Publication No. 2015/0003673;

### U.S. Patent Application Publication No. 2015/0009338;

### U.S. Patent Application Publication No. 2015/0009610;

### U.S. Patent Application Publication No. 2015/0014416;

### U.S. Patent Application Publication No. 2015/0021397;

### U.S. Patent Application Publication No. 2015/0028102;

### U.S. Patent Application Publication No. 2015/0028103;

### U.S. Patent Application Publication No. 2015/0028104;

### U.S. Patent Application Publication No. 2015/0029002;

### U.S. Patent Application Publication No. 2015/0032709;

### U.S. Patent Application Publication No. 2015/0039309;

### U.S. Patent Application Publication No. 2015/0039878;

### U.S. Patent Application Publication No. 2015/0040378;

### U.S. Patent Application Publication No. 2015/0048168;

### U.S. Patent Application Publication No. 2015/0049347;

### U.S. Patent Application Publication No. 2015/0051992;

### U.S. Patent Application Publication No. 2015/0053766;

### U.S. Patent Application Publication No. 2015/0053768;

### U.S. Patent Application Publication No. 2015/0053769;

### U.S. Patent Application Publication No. 2015/0060544;

### U.S. Patent Application Publication No. 2015/0062366;

### U.S. Patent Application Publication No. 2015/0063215;

### U.S. Patent Application Publication No. 2015/0063676;

### U.S. Patent Application Publication No. 2015/0069130;

### U.S. Patent Application Publication No. 2015/0071819;

### U.S. Patent Application Publication No. 2015/0083800;

### U.S. Patent Application Publication No. 2015/0086114;

### U.S. Patent Application Publication No. 2015/0088522;

### U.S. Patent Application Publication No. 2015/0096872;

### U.S. Patent Application Publication No. 2015/0099557;

### U.S. Patent Application Publication No. 2015/0100196;

### U.S. Patent Application Publication No. 2015/0102109;

### U.S. Patent Application Publication No. 2015/0115035;

### U.S. Patent Application Publication No. 2015/0127791;

### U.S. Patent Application Publication No. 2015/0128116;

### U.S. Patent Application Publication No. 2015/0129659;

### U.S. Patent Application Publication No. 2015/0133047;

### U.S. Patent Application Publication No. 2015/0134470;

### U.S. Patent Application Publication No. 2015/0136851;

### U.S. Patent Application Publication No. 2015/0136854;

### U.S. Patent Application Publication No. 2015/0142492;

### U.S. Patent Application Publication No. 2015/0144692;

### U.S. Patent Application Publication No. 2015/0144698;

### U.S. Patent Application Publication No. 2015/0144701;

### U.S. Patent Application Publication No. 2015/0149946;

### U.S. Patent Application Publication No. 2015/0161429;

### U.S. Patent Application Publication No. 2015/0169925;

### U.S. Patent Application Publication No. 2015/0169929;

### U.S. Patent Application Publication No. 2015/0178523;

### U.S. Patent Application Publication No. 2015/0178534;

### U.S. Patent Application Publication No. 2015/0178535;

### U.S. Patent Application Publication No. 2015/0178536;

### U.S. Patent Application Publication No. 2015/0178537;

### U.S. Patent Application Publication No. 2015/0181093;

### U.S. Patent Application Publication No. 2015/0181109;

U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/458,405 for an Electronic Device, filed Jun. 19, 2013 (Fitch et al.);
U.S. patent application Ser. No. 29/459,620 for an Electronic Device Enclosure, filed Jul. 2, 2013 (London et al.);
U.S. patent application Ser. No. 29/468,118 for an Electronic Device Case, filed Sep. 26, 2013 (Oberpriller et al.);
U.S. patent application Ser. No. 14/150,393 for Indicia-reader Having Unitary Construction Scanner, filed Jan. 8, 2014 (Colavito et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 29/486,759 for an Imaging Terminal, filed Apr. 2, 2014 (Oberpriller et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/334,934 for a SYSTEM AND METHOD FOR INDICIA VERIFICATION, filed Jul. 18, 2014 (Hejl);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/483,056 for VARIABLE DEPTH OF FIELD BARCODE SCANNER filed Sep. 10, 2014 (McCloskey et al.);
U.S. patent application Ser. No. 14/513,808 for IDENTIFYING INVENTORY ITEMS IN A STORAGE FACILITY filed Oct. 14, 2014 (Singel et al.);
U.S. patent application Ser. No. 14/519,195 for HANDHELD DIMENSIONING SYSTEM WITH FEEDBACK filed Oct. 21, 2014 (Laffargue et al.);
U.S. patent application Ser. No. 14/519,179 for DIMENSIONING SYSTEM WITH MULTIPATH INTERFERENCE MITIGATION filed Oct. 21, 2014 (Thuries et al.);
U.S. patent application Ser. No. 14/519,211 for SYSTEM AND METHOD FOR DIMENSIONING filed Oct. 21, 2014 (Ackley et al.);
U.S. patent application Ser. No. 14/519,233 for HANDHELD DIMENSIONER WITH DATA-QUALITY INDICATION filed Oct. 21, 2014 (Laffargue et al.);
U.S. patent application Ser. No. 14/519,249 for HANDHELD DIMENSIONING SYSTEM WITH MEASUREMENT-CONFORMANCE FEEDBACK filed Oct. 21, 2014 (Ackley et al.);
U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.);
U.S. patent application Ser. No. 14/529,563 for ADAPTABLE INTERFACE FOR A MOBILE COMPUTING DEVICE filed Oct. 31, 2014 (Schoon et al.);
U.S. patent application Ser. No. 14/529,857 for BARCODE READER WITH SECURITY FEATURES filed Oct. 31, 2014 (Todeschini et al.);
U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
U.S. patent application Ser. No. 14/531,154 for DIRECTING AN INSPECTOR THROUGH AN INSPECTION filed Nov. 3, 2014 (Miller et al.);
U.S. patent application Ser. No. 14/533,319 for BARCODE SCANNING SYSTEM USING WEARABLE DEVICE WITH EMBEDDED CAMERA filed Nov. 5, 2014 (Todeschini);
U.S. patent application Ser. No. 14/535,764 for CONCATENATED EXPECTED RESPONSES FOR SPEECH RECOGNITION filed Nov. 7, 2014 (Braho et al.);
U.S. patent application Ser. No. 14/568,305 for AUTO-CONTRAST VIEWFINDER FOR AN INDICIA READER filed Dec. 12, 2014 (Todeschini);
U.S. patent application Ser. No. 14/573,022 for DYNAMIC DIAGNOSTIC INDICATOR GENERATION filed Dec. 17, 2014 (Goldsmith);
U.S. patent application Ser. No. 14/578,627 for SAFETY SYSTEM AND METHOD filed Dec. 22, 2014 (Ackley et al.);
U.S. patent application Ser. No. 14/580,262 for MEDIA GATE FOR THERMAL TRANSFER PRINTERS filed Dec. 23, 2014 (Bowles);
U.S. patent application Ser. No. 14/590,024 for SHELVING AND PACKAGE LOCATING SYSTEMS FOR DELIVERY VEHICLES filed Jan. 6, 2015 (Payne);
U.S. patent application Ser. No. 14/596,757 for SYSTEM AND METHOD FOR DETECTING BARCODE PRINTING ERRORS filed Jan. 14, 2015 (Ackley);
U.S. patent application Ser. No. 14/416,147 for OPTICAL READING APPARATUS HAVING VARIABLE SETTINGS filed Jan. 21, 2015 (Chen et al.);
U.S. patent application Ser. No. 14/614,706 for DEVICE FOR SUPPORTING AN ELECTRONIC TOOL ON A USER'S HAND filed Feb. 5, 2015 (Oberpriller et al.);
U.S. patent application Ser. No. 14/614,796 for CARGO APPORTIONMENT TECHNIQUES filed Feb. 5, 2015 (Morton et al.);
U.S. patent application Ser. No. 29/516,892 for TABLE COMPUTER filed Feb. 6, 2015 (Bidwell et al.);
U.S. patent application Ser. No. 14/619,093 for METHODS FOR TRAINING A SPEECH RECOGNITION SYSTEM filed Feb. 11, 2015 (Pecorari);
U.S. patent application Ser. No. 14/628,708 for DEVICE, SYSTEM, AND METHOD FOR DETERMINING THE STATUS OF CHECKOUT LANES filed Feb. 23, 2015 (Todeschini);
U.S. patent application Ser. No. 14/630,841 for TERMINAL INCLUDING IMAGING ASSEMBLY filed Feb. 25, 2015 (Gomez et al.);
U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
U.S. patent application Ser. No. 29/519,017 for SCANNER filed Mar. 2, 2015 (Zhou et al.);
U.S. patent application Ser. No. 14/405,278 for DESIGN PATTERN FOR SECURE STORE filed Mar. 9, 2015 (Zhu et al.);
U.S. patent application Ser. No. 14/660,970 for DECODABLE INDICIA READING TERMINAL WITH COMBINED ILLUMINATION filed Mar. 18, 2015 (Kearney et al.);
U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
U.S. patent application Ser. No. 14/662,922 for MULTIFUNCTION POINT OF SALE SYSTEM filed Mar. 19, 2015 (Van Horn et al.);
U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
U.S. patent application Ser. No. 14/669,280 for TRANSFORMING COMPONENTS OF A WEB PAGE TO VOICE PROMPTS filed Mar. 26, 2015 (Funyak et al.);
U.S. patent application Ser. No. 14/674,329 for AIMER FOR BARCODE SCANNING filed Mar. 31, 2015 (Bidwell);
U.S. patent application Ser. No. 14/676,109 for INDICIA READER filed Apr. 1, 2015 (Huck);
U.S. patent application Ser. No. 14/676,327 for DEVICE MANAGEMENT PROXY FOR SECURE DEVICES filed Apr. 1, 2015 (Yeakley et al.);
U.S. patent application Ser. No. 14/676,898 for NAVIGATION SYSTEM CONFIGURED TO INTEGRATE MOTION SENSING DEVICE INPUTS filed Apr. 2, 2015 (Showering);
U.S. patent application Ser. No. 14/679,275 for DIMENSIONING SYSTEM CALIBRATION SYSTEMS AND METHODS filed Apr. 6, 2015 (Laffargue et al.);
U.S. patent application Ser. No. 29/523,098 for HANDLE FOR A TABLET COMPUTER filed Apr. 7, 2015 (Bidwell et al.);
U.S. patent application Ser. No. 14/682,615 for SYSTEM AND METHOD FOR POWER MANAGEMENT OF MOBILE DEVICES filed Apr. 9, 2015 (Murawski et al.);
U.S. patent application Ser. No. 14/686,822 for MULTIPLE PLATFORM SUPPORT SYSTEM AND METHOD filed Apr. 15, 2015 (Qu et al.);
U.S. patent application Ser. No. 14/687,289 for SYSTEM FOR COMMUNICATION VIA A PERIPHERAL HUB filed Apr. 15, 2015 (Kohtz et al.);
U.S. patent application Ser. No. 29/524,186 for SCANNER filed Apr. 17, 2015 (Zhou et al.);
U.S. patent application Ser. No. 14/695,364 for MEDICATION MANAGEMENT SYSTEM filed Apr. 24, 2015 (Sewell et al.);
U.S. patent application Ser. No. 14/695,923 for SECURE UNATTENDED NETWORK AUTHENTICATION filed Apr. 24, 2015 (Kubler et al.);
U.S. patent application Ser. No. 29/525,068 for TABLET COMPUTER WITH REMOVABLE SCANNING DEVICE filed April 27, 2015 (Schulte et al.);
U.S. patent application Ser. No. 14/699,436 for SYMBOL READING SYSTEM HAVING PREDICTIVE DIAGNOSTICS filed Apr. 29, 2015 (Nahill et al.);
U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
U.S. patent application Ser. No. 14/702,979 for TRACKING BATTERY CONDITIONS filed May 4, 2015 (Young et al.);
U.S. patent application Ser. No. 14/704,050 for INTERMEDIATE LINEAR POSITIONING filed May 5, 2015 (Charpentier et al.);
U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
U.S. patent application Ser. No. 14/707,123 for APPLICATION INDEPENDENT DEX/UCS INTERFACE filed May 8, 2015 (Pape);
U.S. patent application Ser. No. 14/707,492 for METHOD AND APPARATUS FOR READING OPTICAL INDICIA USING A PLURALITY OF DATA SOURCES filed May 8, 2015 (Smith et al.);
U.S. patent application Ser. No. 14/710,666 for PRE-PAID USAGE SYSTEM FOR ENCODED INFORMATION READING TERMINALS filed May 13, 2015 (Smith);
U.S. patent application Ser. No. 29/526,918 for CHARGING BASE filed May 14, 2015 (Fitch et al.);
U.S. patent application Ser. No. 14/715,672 for AUGUMENTED REALITY ENABLED HAZARD DISPLAY filed May 19, 2015 (Venkatesha et al.);
U.S. patent application Ser. No. 14/715,916 for EVALUATING IMAGE VALUES filed May 19, 2015 (Ackley);
U.S. patent application Ser. No. 14/722,608 for INTERACTIVE USER INTERFACE FOR CAPTURING A DOCUMENT IN AN IMAGE SIGNAL filed May 27, 2015 (Showering et al.);
U.S. patent application Ser. No. 29/528,165 for IN-COUNTER BARCODE SCANNER filed May 27, 2015 (Oberpriller et al.);
U.S. patent application Ser. No. 14/724,134 for ELECTRONIC DEVICE WITH WIRELESS PATH SELECTION CAPABILITY filed May 28, 2015 (Wang et al.);
U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
U.S. patent application Ser. No. 14/724,908 for IMAGING APPARATUS HAVING IMAGING ASSEMBLY filed May 29, 2015 (Barber et al.);
U.S. patent application Ser. No. 14/725,352 for APPARATUS AND METHODS FOR MONITORING ONE OR MORE PORTABLE DATA TERMINALS (Caballero et al.);
U.S. patent application Ser. No. 29/528,590 for ELECTRONIC DEVICE filed May 29, 2015 (Fitch et al.);
U.S. patent application Ser. No. 29/528,890 for MOBILE COMPUTER HOUSING filed Jun. 2, 2015 (Fitch et al.);
U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
U.S. patent application Ser. No. 14/732,870 for DATA COLLECTION MODULE AND SYSTEM filed Jun. 8, 2015 (Powilleit);
U.S. patent application Ser. No. 29/529,441 for INDICIA READING DEVICE filed Jun. 8, 2015 (Zhou et al.);
U.S. patent application Ser. No. 14/735,717 for INDICIA-READING SYSTEMS HAVING AN INTERFACE WITH A USER'S NERVOUS SYSTEM filed Jun. 10, 2015 (Todeschini);
U.S. patent application Ser. No. 14/738,038 for METHOD OF AND SYSTEM FOR DETECTING OBJECT WEIGHING INTERFERENCES filed Jun. 12, 2015 (Amundsen et al.);
U.S. patent application Ser. No. 14/740,320 for TACTILE SWITCH FOR A MOBILE ELECTRONIC DEVICE filed Jun. 16, 2015 (Bandringa);
U.S. patent application Ser. No. 14/740,373 for CALIBRATING A VOLUME DIMENSIONER filed Jun. 16, 2015 (Ackley et al.);
U.S. patent application Ser. No. 14/742,818 for INDICIA READING SYSTEM EMPLOYING DIGITAL GAIN CONTROL filed Jun. 18, 2015 (Xian et al.);
U.S. patent application Ser. No. 14/743,257 for WIRELESS MESH POINT PORTABLE DATA TERMINAL filed Jun. 18, 2015 (Wang et al.);
U.S. patent application Ser. No. 29/530,600 for CYCLONE filed Jun. 18, 2015 (Vargo et al);
U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
U.S. patent application Ser. No. 14/744,836 for CLOUD-BASED SYSTEM FOR READING OF DECODABLE INDICIA filed Jun. 19, 2015 (Todeschini et al.);
U.S. patent application Ser. No. 14/745,006 for SELECTIVE OUTPUT OF DECODED MESSAGE DATA filed Jun. 19, 2015 (Todeschini et al.);
U.S. patent application Ser. No. 14/747,197 for OPTICAL PATTERN PROJECTOR filed Jun. 23, 2015 (Thuries et al.);
U.S. patent application Ser. No. 14/747,490 for DUAL-PROJECTOR THREE-DIMENSIONAL SCANNER filed Jun. 23, 2015 (Jovanovski et al.); and
U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

What is claimed is:

1. A method comprising:
charging a device coupled to a charger;
detecting a charger attached power supply configuration; and
limiting a charge current of the charger based on the detected power supplies.

2. The method of claim 1, wherein detecting an attached power supply configuration includes detecting changes to the power supply configuration.

3. The method of claim 2, wherein detecting changes includes detecting insertion and removal of power supply connectors to the charger while charging the device.

4. The method of claim 1, wherein the charger supply configuration comprises at least one of a USB power supply coupled to the charger via a USB connector and an AC adapter power supply coupled to the charger via a barrel connector.

5. The method of claim 4, wherein a USB power supply is coupled to the charger and wherein upon detection of an AC adapter power supply being connected, the method further comprises disabling a USB charge path.

6. The method of claim 4, wherein upon detection of only a USB power supply being coupled to the charger, the charge current is limited to approximately 500 mA.

7. The method of claim 4, wherein limiting a charge current comprises limiting charge current in a USB charge path independently of limiting charge current in a separate AC adapter charge path.

8. The method of claim 7, wherein the current in the USB charge path is limited to approximately 500 mA and the current in the AC adapter charge path is limited to approximately 1 A.

9. The method of claim 1, wherein detecting a charger attached power supply configuration comprises detecting the presence of a supply voltage on a given input pin.

10. The method of claim 1, wherein detecting a charger attached power supply configuration comprises receiving an identification signal from an attached power supply.

11. A device comprising:
a charger connector;
a power supply configuration detector coupled to the charger connector to detect a power supply configuration; and
a current limiter coupled to the power supply configuration detector to limit charge current based on the detected power supply configuration.

12. The device of claim 11, wherein the charger connector comprises a cradle having multiple pins to couple to a charge storage element.

13. The device of claim 11, wherein the power supply configuration detector detects changes to the power supply configuration.

14. The device of claim 13, wherein the power supply configuration detector detects insertion and removal of power supply connectors to the charger while charging the device.

15. The device of claim 11, wherein the charger supply configuration comprises at least one of a USB power supply to couple to the charger via a USB connector and an AC adapter power supply to couple to the charger via a barrel connector.

16. The device of claim 15, further comprising separate charge paths for each different power supply in the power supply configuration, and wherein the current limiter is configured to disable a USB charge path upon detection of an AC adapter power supply being connected.

17. The device of claim 15, wherein the current limiter is configured to limit charge current to approximately 500 mA when a USB power supply is connected to the charge connector.

18. The device of claim 15, wherein the current limiter limits a charge current in a USB charge path independently of limiting charge current in a separate AC adapter charge path.

19. The device of claim 18, wherein the current in the USB charge path is limited to approximately 500 mA and the current in the AC adapter charge path is limited to approximately 1 A.

20. The device of claim 11, wherein the power supply configuration detector detects the presence of a supply voltage on a given input pin.

21. The device of claim 11, wherein the power supply configuration detector receives an identification signal from an attached power supply.
